(19) United States
(12) Patent Application Publication
(10) Pub. No.: US 2011/0277897 A1
(43) Pub. Date: Nov. 17, 2011

(54) PNEUMATIC TIRE

(75) Inventor: Seiji Yokomakura, Osaka (JP)

(73) Assignee: TOYO TIRE & RUBBER CO., LTD., Osaka (JP)

(21) Appl. No.: 13/108,181

(22) Filed: May 16, 2011

(30) Foreign Application Priority Data
May 17, 2010 (JP) 2010-113438

(51) Int. Cl. B60C 11/117

(52) U.S. Cl. 152/209.18

(57) ABSTRACT

An object of the present invention is to provide a pneumatic tire capable of, while restricting deformation of groove portions to prevent groove cracks, preventing chipping-off or break-off of protruding portions formed on wall surfaces of the groove as well as preventing irregular wear of the tire. In order to achieve the object, a pneumatic tire comprises a tread surface formed with a plurality of groove portions thereon, wherein at least one of the wall surfaces of the groove portion includes protruding portions and cut-off portions opened to the groove wall surface, and the protruding portions and the cut-off portions are formed alternately on the groove wall surface in an extending direction thereof.

### BACKGROUND OF THE INVENTION

1. Field of the Invention

The present invention relates to a pneumatic tire having a tread surface formed with a plurality of groove portions thereon.

2. Description of the Related Art

In order to enhance drainage performance, traction performance, braking performance or the like, pneumatic tires have a tread surface formed with a plurality of main grooves extending in a circumferential direction of the tire as well as a plurality of transverse grooves extending in a width direction of the tire. When brake is applied or while turning a vehicle, these groove portions are subjected to a large load causing a large deformation in a direction reducing the groove width. At this time, strain converges on the bottom of groove causing cracks (groove cracks). Thus, the deformation of tire may cause a problem in an aspect of the durability of the tire.

As a technique to reduce convergence of strain on the bottom of groove, there is known a technique in which curvature radius at the bottom of groove is arranged to be larger. However, this technique cannot restrict deformation of groove portion, particularly on the tread surface side portion of tire. Therefore, tires are prone to irregular wear in edge line area (edge portion) formed by groove portion and tread surface therebetween. The deformation of groove portion in an area at the tread surface side portion can be restricted by setting a smaller curvature radius at the bottom of groove or by arranging a plurality of protruding portions at the bottom of groove. However, this technique cannot prevent the generation of cracks at the bottom of groove.

Patent document 1 teaches a pneumatic tire described below. That is, the tire is arranged so that, when block yields to a force and transverse grooves are deformed, protruding portions that are formed on wall surfaces of the block come into contact with each other so as to support blocks each other to thereby enhance the stiffness of blocks. However, when protruding portions support each other, strain converges on base portion of the protruding portions causing cracks in this area. Chipping-off and break-off tend to be generated on the protruding portions. Further, the strain converges on the base portion of the protruding portions located at the tread surface side, and contact pressure is increased in the edge portion adjacent to the protruding portion. As a result, this area tends to be partially worn and thus a irregular wear is generated.

Patent document 2 also teaches a pneumatic tire described below. That is, the pneumatic tire is arranged so that a plurality of narrow grooves are formed in an area outer than a main groove formed on the tread surface, and a plurality of protruding portions are formed on the wall surfaces of the narrow grooves. In this constitution of the pneumatic tire, when narrow grooves are deformed, the protruding portions support each other to thereby prevent block end portion of the narrow groove located at the shoulder side from being bent toward the narrow groove. Also in this technique, the above problems such as chipping-off and break-off of the protruding portion as well as irregular wear of the tire still remains.

Patent document 3 teaches a pneumatic tire described below. That is, the pneumatic tire is arranged so that, in order to reduce noises caused from resonant of an air-column generated by the tire, the wall surfaces of main groove are formed with protruding portions, one end of which located at the tread surface side is generally parallel to the tread surface. However, in this pneumatic tire, when the protruding portions come into contact with each other or when the protruding portions and opposing wall surfaces of the groove come into contact with each other to support each other, there remain the above problems such as chipping-off and break-off of the protruding portion as well as irregular wear of the tire.
Patent document 1; Japanese Unexamined Patent Publication No. 06-191231
Patent document 2; Japanese Unexamined Patent Publication No. 2006-137231
Patent document 3; Japanese Unexamined Patent Publication No. 2005-263087

### SUMMARY OF THE INVENTION

The present invention has been proposed in view of the above circumstances. An object of the present invention is to provide a pneumatic tire capable of, while restricting deformation of groove portions to prevent groove cracks, preventing chipping-off or break-off of protruding portions formed on wall surfaces of the groove as well as preventing irregular wear of the tire.

The above object can be achieved by the present invention described below. That is, the pneumatic tire according to the present invention is a pneumatic tire includes a tread surface formed with a plurality of groove portions thereon, wherein at least one of the wall surfaces of the groove portion includes a plurality of protruding portions and a plurality of cut-off portions opened to the groove wall surface, the protruding portions and the cut-off portions are formed alternately on the groove wall surface in an extending direction thereof.

In the pneumatic tire, when a large load is applied to the groove portion during running, each of the protruding portions supports the land portions partitioned by the groove portions, thereby deformation of the groove portion can be restricted. As a result, convergence of strain at the bottom of groove is restricted, and thus groove cracks can be prevented from being generated. Further, since the cut-off portions that are opened to the wall surface of the groove are formed alternately with the protruding portions, the cut-off portions absorb the stress at the base portion of the protruding portions supporting the land portions, and thus the convergence of strain can be reduced. As a result, chipping-off or break-off of the protruding portions can be prevented as well as contact pressure can be restricted from increasing at the edge portion adjacent to the protruding portion. Thus irregular wear of the tire can be prevented.

In the pneumatic tire, each of the protruding portions is preferably formed being separated away from the bottom of the groove portion to the outer side thereof as viewed in a radial direction of the tire. With this constitution, since a larger curvature radius can be set at the bottom of the groove, deformation of the groove portions can be restricted; and thus groove cracks can be prevented from being generated more reliably.

In the pneumatic tire, the distance between the protruding portion and the cut-off portion is preferably smaller than the width of the protruding portion as viewed in the extending direction of the groove portion. With this constitution, the protruding portions and the cut-off portions are disposed at appropriate distance from each other. Therefore, the stress at the base portion of the protruding portions can be absorbed effectively by the cut-off portions. As a result, irregular wear of the tire as well as chipping-off and break-off of the protruding portions can be prevented more reliably.

In the pneumatic tire, the height of each of the protruding portions from the groove wall surface is preferably 20 to 60% of the width of the groove portion. With this constitution, the stress at the base portion of the protruding portions can be reduced while ensuring the drainage performance of the groove portions and the protruding portions reliably support the land portions. Thus, deformation of the groove portions can be restricted.

In the pneumatic tire, the protruding portions and the cut-off portions are formed on both wall surfaces of the groove portion, wherein the protruding portions on both wall surfaces of the groove portion may be disposed so as to opposite to each other as viewed in a groove width direction. With this constitution, since the protruding portions support each other, particularly in the groove portions having a relatively large width, deformation of the groove portions can be effectively restricted.

In the pneumatic tire, the protruding portions and the cut-off portions are formed on both wall surfaces of the groove portion, wherein the protruding portions on both wall surfaces of the groove portion may be disposed so as not to opposite to each other as viewed in a groove width direction. With this constitution, the protruding portions come into contact with the opposing wall surface of the groove and support the land portion respectively. Particularly in the groove portion having a relatively small width, deformation thereof can be effectively restricted.

### BRIEF DESCRIPTION OF THE DRAWINGS

FIG. 1 illustrates an example of a tread surface of a pneumatic tire according to the present invention;

FIG. 2 is an enlarged view illustrating an example of an essential portion of the tread surface of the pneumatic tire according to the present invention;

FIG. 3 is a sectional view taken along line I-I in FIG. 2;

FIG. 4 is a sectional view taken along line II-II in FIG. 2;

FIG. 5 is a perspective view illustrating an example of a protruding portion and a cut-off portion according to the present invention; and

FIG. 6 is a perspective view illustrating a protruding portion and a cut-off portion of Comparative Example 2.

### DETAILED DESCRIPTION OF THE INVENTION

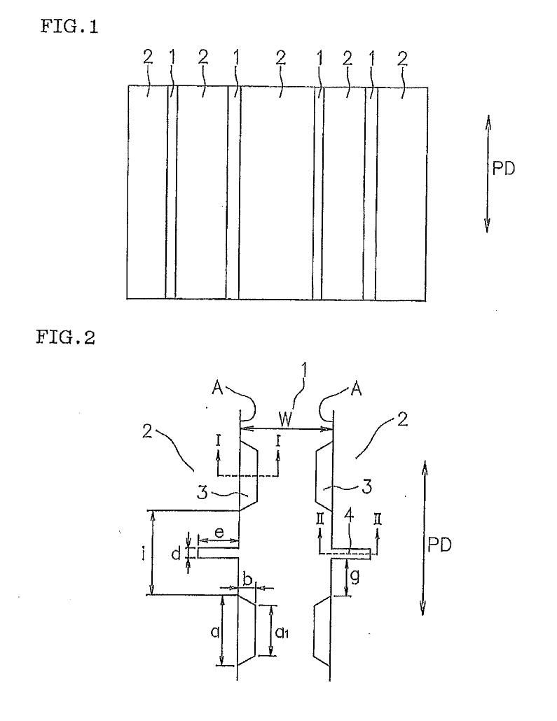

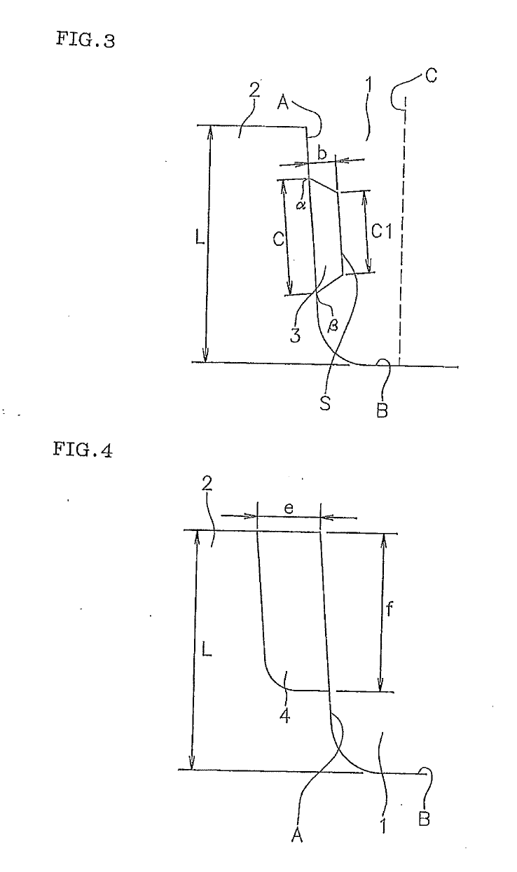

Embodiments of the present invention will be described below with reference to the accompanying drawings. FIG. 1 illustrates an example of a tread surface of a pneumatic tire according to the present invention; FIG. 2 is an enlarged view illustrating an example of an essential portion of the tread surface of the pneumatic tire according to the present invention; FIG. 3 is a sectional view taken along line I-I in FIG. 2; and FIG. 4 is a sectional view taken along line II-II in FIG. 2.

Referring to FIG. 1, the pneumatic tire of the present embodiment includes four main grooves 1 formed as groove portions extending straightly in a circumferential direction PD of the tire on the tread surface of the tire. Further, the tread surface includes a plurality of ribs 2 formed as land portions that are partitioned by the main grooves 1 or a tread end. The embodiment shows an example in which the land portions include the ribs 2. According to the present invention, the same performance is obtained by a plurality of blocks, which are partitioned by the main grooves 1 and a plurality of transverse grooves extending in a width direction of the tire.

Referring to FIG. 2, on the both side wall surfaces A of the main groove 1, a plurality of protruding portions 3 and a plurality of cut-off portions 4 opened to the wall surface A are formed alternately along the extending direction of the respective main grooves 1; and the protruding portions 3 are formed on the respective wall surfaces A of the groove at positions opposing to each other as viewed in a groove width direction. The embodiment gives an example in which the sipes 4 are formed as the cut-off portions 4.

With the above constitution, when a large load is applied to the main groove 1 of the tire during running, the opposing protruding portions 3 come into contact with each other and support the ribs 2 partitioned from each other by the main groove 1. Thereby, the deformation of the main groove 1 in a groove width reducing direction can be restricted. As a result, strain is prevented from being converged on the bottom B of the main groove 1 preventing generation of groove cracks. Further, since the protruding portions 3 and the sipes 4 opened to the wall surfaces A of the groove are formed alternately, the stress is absorbed by the sipes 4 at the base portion of the protruding portions 3 supporting the ribs 2; thereby the convergence of strain can be reduced. As a result, the protruding portions 3 can be prevented from being chipped-off or broken off and the contact pressure is prevented from increasing at the edge portion adjacent to the protruding portions 3; thereby the irregular wear of the tire can be prevented.

Each of the protruding portions 3 is preferably formed so that the distance between the protruding portions 3 becomes larger from the bottom B of the main groove 1 toward the outer side (upper side in FIG. 3) as viewed in a radial direction of the tire as shown in FIG. 3. This constitution ensures a larger curvature radius at the bottom B. Accordingly, the deformation of the main groove 1 is restricted and the groove cracks can be prevented from being generated more reliably. Particularly, according to the present invention, the protruding portion 3 is preferably disposed so that an inner side end β thereof is disposed at a point of 60 to 90% of depth of the groove L in the main groove 1 from the tread surface as viewed in the radial direction of the tire. If the value is smaller than 60%, the effect of the protruding portions 3 to prevent the deformation of the main groove 1 may be reduced. If the value exceeds 90%, the protruding portion 3 and the bottom B of the main groove 1 may interfere with each other and groove cracks may be caused.

Also, the protruding portion 3 is preferably formed so that an end a located at the outer side thereof is positioned at a point inner than the tread surface (lower side in FIG. 3) as viewed in the radial direction of the tire. With this constitution, the protruding portion 3 is not exposed from the tread surface. Accordingly, irregular wear of the tire, which is caused from the deformation of the shape of the main groove 1 at the tread surface, can be effectively prevented. Particularly, according to the present invention, the protruding portion 3 is preferably arranged so that the outer side end a thereof is positioned at a point of 10 to 20% of a depth of the groove L of the main groove 1 from the tread surface as viewed in a radial direction of the tire. If the value is smaller than 10%, above-described irregular wear may be caused. If the value is greater than 20%, the effect of the protruding portion 3 to restrict the deformation of the main groove 1 may be reduced.

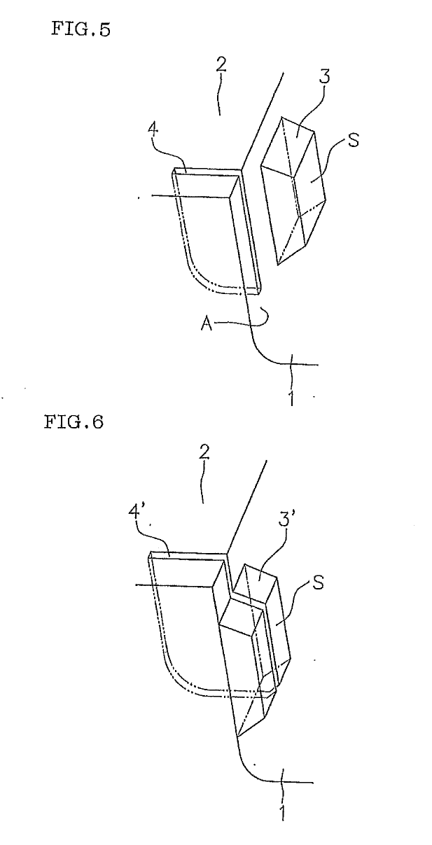

According to the embodiment, the protruding portion 3 includes a flat plane S opposing to the groove wall surface A as illustrated in FIG. 3 and FIG. 5. An inclination angle formed by the flat plane S and a groove reference plane C therebetween is preferably 0 to θ° (θ is an angle formed by the groove reference plane C and the groove wall surface A including protruding portion 3 formed thereon). With this constitution, when the main groove 1 is deformed in a direction where the groove width is reduced, the protruding portions 3 can support the ribs 2 at early stage. Further, when the protruding portions 3 support the ribs 2, stress can be dispersed to the entire of flat plane S of the protruding portion 3. Accordingly, irregular wear of the tire, chipping-off and break-off of the protruding portion 3 can be reliably prevented. Here, the wording “groove reference plane” means a plane that goes through a central line of the groove portion as viewed in the width direction.

The height “b” of the protruding portion 3 from the groove wall surface is preferably set to 20 to 60% of groove width W of the main groove 1. When the value is smaller than 20%, the effect of the protruding portion 3 to restrict the deformation of the main groove 1 may be reduced. When the value is larger than 60%, the stress tends to converge on the base portion of the protruding portion 3, the drainage performance of the main groove 1 may be deteriorated. Furthermore, the width “a” of the protruding portion 3 in an extending direction of the main groove 1 is preferably larger than the height “b” of the protruding portion 3 from the groove wall surface A. The length “c” of the protruding portion 3 in a depth direction is preferably larger than the height “b”. With this constitution, the protruding portion 3 is formed flatly and the deformation of the main groove 1 can be effectively restricted. Here, the wording “groove width W” means the width W on the tread surface. The width “a” of the protruding portion 3 in the extending direction of the main groove 1 means the width “a” on the base portion of the protruding portion 3. The height “b” of the protruding portion 3 from the groove wall surface A means the height “b” measured at the center of the base portion of the protruding portion 3 in a vertical direction with respect to the groove wall surface A. In the present invention, the width a of the protruding portion 3 is set to, for example, 8 to 20 mm; and the length “c” in the depth direction is set to, for example, 8 to 20 mm.

Relationship between the distance “i” between the neighboring protruding portions 3 in the extending direction of the main groove 1 and the width “a” of the protruding portion 3 is preferably set to satisfy a relationship of a <i<5a. With this constitution, the protruding portions 3 are appropriately disposed within the contact surface of the tire and the deformation of the main groove 1 can be restricted more reliably. Thus, generation reliably. According to the present invention, the distance i is preferably set to, for example, 15 to 100 mm.

According to the embodiment, the distance “g” between the protruding portion 3 and the sipe 4 is set to be smaller than the width “a” of the protruding portion 3. With this constitution, when the protruding portions 3 support the ribs 2, appropriate distance is ensured between the protruding portion 3 and the sipe 4. Accordingly, stress can be absorbed effectively by the sipes 4 at the base portion of the protruding portion 3. As a result, chipping-off and break-off of the protruding portion 3 as well as irregular wear can be reliably prevented. According to the present invention, the distance “g” between the protruding portion 3 and the sipe 4 is set to, for example, 7 to 18 mm.

In the embodiment, the sipes 4 are opened to the groove wall surfaces A on which the protruding portions 3 are formed. The sipes 4 may be opened to the both main grooves 1 or either one of the main grooves. According to the present invention, the width of the sipe 4 is set to, for example, 0.7 to 1.5 mm; the length “e” is set to, for example, 2 to 5 mm; and the sipe depth “f” is set to, for example, 10 to 13 mm.

The pneumatic tire according to the present invention is the same as conventional pneumatic tires excepting a point that the protruding portions and the cut-off portions opened to the wall surfaces of the groove are formed on the groove wall surface of the groove portion. Therefore, any of the conventionally known material, configuration, structure, and manufacturing method may be applied to invention.

### Other Embodiments

(1) The above embodiment gives an example in which the protruding portions 3 and the cut-off portions 4 opened to groove wall surface A are formed on the wall surfaces A of the main groove 1. However, according to the present invention, the protruding portions and the cut-off portions opened to the wall surfaces of the groove may be formed on the wall surfaces of the transverse grooves extending in the width direction of tire. With this constitution, deformation of the transverse grooves can be restricted, and groove crack and irregular wear on the transverse grooves can be prevented.

(2) The above embodiment gives an example in which both side wall surfaces A of the main groove 1 include the protruding portions 3 and the cut-off portions 4 opened to the wall surfaces of the groove A, which are formed alternately along an extending direction of the main groove 1. However, according to the present invention, the protruding portions and the cut-off portions opened to the wall surfaces of the groove may be formed alternately along the extending direction of the groove portion on only one of the wall surfaces of the groove portion. With this constitution, the protruding portions come into contact with the opposing wall surfaces of the groove to thereby support the opposing groove wall. Accordingly, particularly in the groove portion the width of which is relatively small, the deformation of which can be effectively restricted.

(3) The above embodiment gives an example in which the protruding portions 3 formed on the respective wall surfaces of the groove A at positions opposing to each other as viewed in the groove width direction. However, according to the present invention, the protruding portions and the cut-off portions opened to the groove wall surface may be formed alternately along the extending direction of the groove portion on the both wall surfaces of the groove portion, and the protruding portions formed on the respective wall surfaces of the groove may be formed so as not to oppose to each other as viewed in the groove width direction. With this constitution, the protruding portions come into contact with the wall surface of the opposing groove to support the same. Accordingly, particularly in groove portion the width of which is relatively small (for example, thin groove with groove width of about 5 mm), the deformation of the groove can be effectively restricted.

(4) The above embodiment gives an example in which the sipes 4 are formed as cut-off portions 4. However, according to the present invention, notches the width of which is larger than the sipes may be formed as the cut-off portions. Notches with width of 4 to 8 mm may be formed.

(5) The above embodiment gives an example in which sectional shape of the protruding portion 3 is formed in a trapezoidal shape as viewed in the groove width direction of the main groove 1 as illustrated in FIG. 3. However, the sectional shape of the protruding portion 3 may be formed in, for example, a rectangle shape. However, to effectively support the protruding portion with the land portion, the sectional shape of the protruding portion is preferably formed in a trapezoidal shape as viewed in the groove width direction.

### EXAMPLES

Examples illustrating constitution and effects of the present invention will be described below. Evaluation of performances of tires was conducted as described below.

### (1) Irregular Wear Resistance

After running 50,000 km, a total area of irregular wear generated in the edge portion of the main groove was measured on the test tires (11R22.5). Defining the inverse number of the total area of the wear on a Conventional Example as 100, the irregular wear resistance was evaluated using an index number. The larger index value, the superior irregular wear resistance.

### (2) Groove Crack Performance

After running 50,000 km, groove cracks generated at the bottom of the main groove was visually inspected on the test tires (11R22.5) and number of groove cracks was counted. Defining the inverse number of counted number on Conventional Example is 100, groove crack performance was evaluated using an index number. The larger the index value, the superior groove crack performance.

### Example 1

A pneumatic tire of Example 1 was prepared as described below. That is, the tread surface was formed with four main grooves 1 as illustrated in FIG. 1. Protruding portions 3 and sipes 4 were formed on both side wall surfaces A of the main grooves 1 as illustrated in FIGS. 2 to 4, in which the protruding portions 3 were formed being opposite to each other on the respective wall surfaces of the groove A as viewed in a groove width direction. (In the main groove 1, groove width W was 10 mm; depth of the groove L was 16.5 mm; width a of the protruding portion 3 was 8 mm; height “b” was 2 mm; length “c” in a depth direction was 8 mm; width “a1” of the flat plane S of the protruding portion 3 was 6 mm; length “c1” in a depth direction of the flat plane S was 6 mm; width “d” of the sipe 4 was 1 mm; length “e” was 4 mm; sipe depth “f” was 11 mm; distance “g” was 7 mm; and distance “i” was 15 mm). Measured values of the evaluation items are shown in Table 1.

### Example 2

A pneumatic tire of Example 2 has the same constitution as in Example 1, except that the protruding portions 3 formed on the respective wall surfaces of the groove A were disposed so as not to opposite to each other as viewed in a groove width direction. Measured values of the evaluation items are shown in Table 1.

### Conventional Example

A pneumatic tire of Example 2 has the same constitution as in Example 1, except that protruding portions 3 and sipes 4 were not formed in the main grooves 1. Measured values of the evaluation items are shown in Table 1.

### Comparative Example 1

The following pneumatic tire of Comparative Example 1 was prepared. That is, the pneumatic tire of Comparative Example 1 has the same constitution as in Example 1, except that sipes 4 illustrated in FIG. 3 were not formed on either surface of the groove wall of the main groove 1 illustrated in FIG. 1, but only the protruding portions 3 illustrated in FIG. 2 formed on the respective groove wall surface were disposed at points so as to opposite to each other as viewed in a groove width direction. Measured values of the evaluation items are shown in Table 1.

### Comparative Example 2

The following pneumatic tire of Comparative Example 2 was prepared. That is, the pneumatic tire having the same constitution as in Example 1, except that protruding portions 3′ and sipes 4′ illustrated in FIG. 6, were formed on both wall surfaces of the main groove 1 illustrated in FIG. 1 (sipe 4′ was arranged so as to open to the flat plane S′ of the protruding portion 3′ at generally central position of the protruding portion 3′ as viewed in the extending direction of the main groove 1; in which width “d”, length “e”, sipe depth “f” of the sipes 4′ were set the same as the sipe 4). Measured values of the evaluation items are shown in Table 1.

TABLE 1

| | Con- | Com- | Com- | | |
|---|---|---|---|---|---|
| | ventional | parative | parative | | |
| | Example | Example 1 | Example 2 | Example 1 | Example 2 |
| Irregular | 100 | 90 | 90 | 110 | 110 |
| wear | | | | | |
| resistance | | | | | |
| Groove | 100 | 110 | 110 | 110 | 110 |
| crack | | | | | |
| performance | | | | | |

In the pneumatic tire of Conventional Example, due to the deformation of the main grooves 1, groove cracks and river wear, in which edge portion of the rib 2 was partially worn in a circumferential direction, were generated. Contrarily, in the pneumatic tires of Example 1 and Example 2, since the ribs 2 each partitioned by the main grooves 1 were supported by the protruding portions 3, the deformation of the main groove 1 was restricted. Thus, compared to the Conventional Example 1, irregular wear resistance and groove crack performance were enhanced.

In the pneumatic tire of Comparative Example 1, since no sipes were formed, the contact pressure was increased in the edge portion adjacent to the protruding portions 3 supporting the ribs 2. Thus, a wear amount was increased and groove crack performance was lowered. Also in the pneumatic tire of Comparative Example 2, since the stress at the base portion of the protruding portions 3′ supporting the ribs 2 was not absorbed by the sipes 4′, the groove crack performance was lowered.

What is claimed is:

1. A pneumatic tire comprising a tread surface formed with a plurality of groove portions thereon, wherein
at least one of the wall surfaces of the groove portion includes protruding portions and cut-off portions opened to the groove wall surface, and the protruding portions and the cut-off portions are formed alternately on the groove wall surface in an extending direction thereof.

2. The pneumatic tire according to claim 1, wherein each of the protruding portions is formed being separated away from a bottom of the groove portion to an outer side thereof as viewed in a radial direction of the tire.

3. The pneumatic tire according to claim 1, wherein the distance between the protruding portion and the cut-off portion is smaller than the width of the protruding portion as viewed in the extending direction of the groove portion.

4. The pneumatic tire according to claim 1, wherein the height of each of the protruding portions from the groove wall surface is from 20 to 60% of the width of the groove portion.

5. The pneumatic tire according to claim 1, wherein the protruding portions and the cut-off portions are formed on both wall surfaces of the groove portion, and the protruding portions on both wall surfaces of the groove are disposed so as to opposite to each other as viewed in a groove width direction.

6. The pneumatic tire according to claim 1, wherein the protruding portions and the cut-off portions are formed on both wall surfaces of the groove portion, and the protruding portions on both wall surfaces of the groove are disposed so as not to opposite to each other as viewed in a groove width direction.
